(19) United States
(12) Patent Application Publication
(10) Pub. No.: US 2002/0113024 A1
(43) Pub. Date: Aug. 22, 2002

(54) Process and device for supercritical wet oxidation

(76) Inventors: Stephan Pilz, Hanau (DE); Margit Veeh, Ulm (DE); Kolja Rebstock, Ulm (DE)

Correspondence Address: Stephan A. Pendorf, Pendorf & Cutliff, P.O. Box 20445, Tampa, FL, 33622-0445, US

(21) Appl. No.: 10/012,841

(22) Filed: Dec. 10, 2001

(30) Foreign Application Priority Data
Dec. 9, 2000 (DE) 100 61 386.1

(51) Int. Cl. C02F 1/72

(52) U.S. Cl. 210/761

(57) ABSTRACT

The invention concerns a process and a device for supercritical wet oxidation of a waste mixture containing particles comprised of organic and inorganic components. In the invention, the waste material mixture is introduced into a vessel (2), which is continuously flowed through by water in the direction counter to gravity, and that a near critical or supercritical condition exists. The flow velocity is so selected, that the particles are kept in suspension, however are not transported in the direction of flow, thereby forming a turbulence layer (30) having an upper boundary. Solids present in the water are discharged and fluid, which is located above the upper limit (32) of the turbulence layer, is continuously removed from the vessel.

### BACKGROUND OF THE INVENTION

1. Field of the Invention

The invention concerns a process and a device for supercritical wet oxidation of a waste mixture containing particles comprised of organic and inorganic components.

Water in supercritical condition performs well as a solvent for organic materials, and besides this, as a reaction medium. These characteristics are taken advantage of for hydrothermal processing of waste material mixtures.

2. Description of the Related Art

A first known reactor concept is a fixed bed reactor, in which the waste material mixture is present as a solid in a bed. Here, however, only relatively small amounts can be handled, in order to avoid too much of a rise in the reaction temperatures in these non-stationary operations. The fixed bed reactor must frequently be opened, and is subjected to dynamic loads. The temperatures and concentrations are unevenly distributed, and the mass transport is hindered by the packing of the solids.

A second reactor concept is a slurry pipe reactor. In the framework of the BMBF-conveyor arrangement for preparing and recycling electronic junk by supercritical wet oxidation (conveyor reference number 01RK9632/8 and 01RK9633/0) a test line was constructed, in which a reactor in the shape of a horizontal, narrow, longitudinally extending pipe is flowed through with water in the near or supercritical condition, in which the waste material particles are suspended and are maintained in suspension by a high flow-through speed, that is, the therewith associated turbulence. In the pipe reactor the organic components are dissolved, cracked or decomposed and oxidized.

A pipe reactor can on the one hand be operated continuously; however the reactor wall suffers not only from abrasion due to the rapidly moving waste material particles, but rather at the same time, it suffers from corrosion due to the near or supercritical water and the therein contained components, and in particular the already decomposed organic components. A further problem is an inadequate space-time yield; the reactor must be relatively long so that the waste material mixture has sufficient residency time therein so that a complete decomposition is achieved.

### SUMMARY OF THE INVENTION

According to the invention one produces, with the aid of water which flows in a near critical or supercritical condition continuously against the direction of gravity, a high pressure turbulence layer comprising particles of a complex waste mixture held in suspension, in order to break the waste material mixture into solid and liquid components taking advantage of the properties of supercritical water. Therewith, there is utilized in accordance to the invention, in place of a fixed bed or a suspension conveyor, a flowing or turbulence bed. Therein the bulk material is subjected to such a strong flow from below that the particles are in a suspension as a loose composite.

In one embodiment an oxidation agent is additionally introduced into the vessel, so that the organic fluid components are dissolved, cracked and oxidized in the same vessel. In this case, this would be referred to as a turbulence layer reactor. The flow speed, which is necessary to maintain the solid particles in the turbulence layer in suspension, is substantially less than the flow speed which would be necessary with a conventional pipe reactor in order to keep the particles in suspension by turbulence in a horizontal flow. Thus the container in which the turbulence layer is produced suffers less from abrasion than a pipe reactor. Besides this, such a turbulence layer reactor is substantially more compact than a pipe reactor.

In another embodiment the liquid components are first separated from all the solid components, and are only then chemically decomposed, in that the oxidizing agent is introduced to them only after leaving the swirl or turbulence layer.

In this case, the bringing into solution of the organic components essentially occurs in the vortex or turbulence layer, and the oxidation of the organic components essentially occurs in a conventional high-pressure reactor. The hydrolysis or cleavage or cracking of the organic components can occur either in the turbulence layer or in a high-pressure reactor, or in both. The various processes during decomposition of the organic components, namely bringing into solution, hydrolysis and oxidation, can in practice not be precisely separated from each other, since they occur partially parallel to each other. However, by an appropriate arrangement of the turbulence layer, one can accomplish that the bringing into solution occurs primarily in the turbulence layer, and by addition of the oxidizing agent only prior to or in the high-pressure reactor, one can accomplish that oxidation essentially occurs only in the high-pressure reactor.

Both the container for the fluidized bed layer as well as the high-pressure reactor can be constructed much more compact than the pipe reactor according to the state of the art in which all three mentioned reactions take place. A small apparatus size in comparison to the waste material being processed is additionally made possible thereby, that the solid material concentration in the turbulence layer is high. Thus, the invention makes possible overall a substantially more compact construction than a pipe reactor according to the state of the art.

The flow speed which is necessary in order to keep the solid particles in suspension in the turbulence layer is essentially less than the fluid flow speed which is necessary with conventional pipe reactors for keeping the particles in the horizontal flow in suspension by turbulence. Thus, the container in which the turbulence layer is produced suffers substantially less from abrasion than a pipe reactor.

Just as in the first embodiment in which the turbulence layer is produced, also in the second embodiment the container suffers relatively little from abrasion, since the flow velocity is relatively small. In the second embodiment the container additionally suffers much less from corrosion, since there occurs in the fluidized bed layer essentially only the bringing into solution of the organic components of the waste material mixture.

In the subsequent or down-stream high-pressure reactor, there is no problem at all with abrasion, since the further decomposition of the organic material occurs completely free of solids.

It is substantially easier to find a material which in the vicinity of the critical condition of water is either corrosion resistant or is abrasion resistant, than to find a material which under the existing conditions is corrosion resistant as well as abrasion resistant. This substantially simplifies the selection of the vessel materials, and the life of the device can be substantially enhanced as compared to a pipe reactor with the same flow-through.

The invention does not suffer from congestion or plugging up, either in the turbulence layer, in which the particles do not tend to clump together, nor in the subsequent high pressure reactor, since this operates free of solids.

In a conventional pipe reactor the energy requirement, in order to convey the water with the therein suspended particles through the long narrow pipe with high flow velocity, is substantial. In the case of the turbulence layer of the invention and, in certain cases, the subsequent high-pressure reactor, the energy requirement for the production of a turbulence layer and the subsequent conveyance is substantially smaller.

The inventive arrangement is particularly suitable for treatment of waste materials with high halogen content, for example electronic debris. The presence of halogens normally causes a particularly intensive corrosion. In the invention, in the fluidized bed the halogens however remain substantially bound in the polymer chains, and salts produced from halogens rapidly precipitate, since inert materials present in the waste material mixture act as crystallization nuclei.

The high-pressure reactor can for example be a CSTR (Continuously Stirred Tank Reactor), a bulbous or barrel shaped tank with stirrer. The stirrer causes a complete mixing thorough of the fluid components in the entire reaction zone. Accordingly, the concentration and temperature within the reactor are locally constant. With this low ratio of internal surface to volume, heat can only be introduced or removed relatively slowly; it is however possible to remove a part of the reaction heat already in the turbulence layer. If necessary, cold water can be added to the CSTR, in order to reduce the caloric or fuel value for the further reaction.

Alternatively, the fluidized bed layer can be operated at low temperatures, that is, in a near critical range, in order to further suppress the corrosion exposure of the container materials, and subsequently the temperature of the fluids leaving the fluidized bed layer can be increased to the supercritical range, so that the oxidation occurs in the supercritical range and therewith particularly effectively. In this case one saves heating energy by using the liberated reaction energy.

In the high pressure reactor, despite low construction space, relatively long dwell times can be realized, which make possible a complete decomposition of the organic components. As a consequence of the good mixing during stirring, there is no need for the dwell time however to be disproportionately high.

On the basis of the bulbous shape of the high-pressure reactor particular measures can be taken, which minimize the corrosion exposure of the reactor material. For example, the reactor walls could be cooled, while the reaction mainly takes place in a hot core zone.

The inventive process for supercritical wet oxidation for chemical decomposition of waste materials is distinguished in that it is advantageously employed not only for treatment of electronic waste as well as waste water and sewage sludge, but rather also for treatment of the shredder light fraction from automobile recycling. The last mentioned waste material mixture, which is comprised in large part of plastic, has occurred recently in particularly large amounts. In comparison to many conventional thermal treatment processes, the inventive process is not a pollutant sink or catcher, and further no new pollutants such as dioxin are produced. Rather, for all materials the cycle can be closed and the recycling quotient can be substantially increased.

The invention is based upon the recognition, that one can produce near or supercritical conditions in one fluidized bed, although near or supercritical water has particular characteristics such as the lack of differentiation between liquid and gas.

### BRIEF DESCRIPTION OF THE DRAWINGS

Further characteristics and advantages of the invention can be seen from the dependent patent claims and from the following description of embodiments illustrated on the basis of the figures. There is shown:

FIG. 1 the density and dynamic viscosity for pure water as a function of temperature at a pressure of 25 MPa,

FIG. 2 the dielectric constant and the ion product for pure water at a pressure of 25 MPa as a function of temperature,

FIG. 3 the solubility of organic and inorganic materials in water as a function of the temperature at pressures of 22.1 through 30 MPa,

FIG. 4 the density of pure water and the diffusion coefficient of a strongly diluted benzole as a function of the temperature at a pressure of 25 MPa,

FIG. 5 a schematic diagram of a facility for supercritical wet oxidation of a waste material mixture,

FIG. 6 a constitutional or equilibrium diagram for the fluidized bed, and

FIG. 7 a schematic for designing the fluidized bed.

### DETAILED DESCRIPTION OF THE INVENTION

A supercritical fluid is a fluid with a temperature above the so-called critical temperature and a pressure above the so-called critical pressure, wherein in a phase diagram the point with the critical temperature and the critical pressure is referred to as the critical point. In the supercritical condition no distinction between liquid and gas is possible. The characteristics of a supercritical fluid can, depending upon temperature and pressure, be gas-like as well as liquid-like.

In supercritical wet oxidation different properties of supercritical water are taken advantage of, for example, the very good solubility property for organic materials and for gases as well as the good characteristics as reaction medium (Clifford A. A.: Chemical destruction using supercritical water; In: Clark J. H.(ed.): Chemistry of waste minimization; 1995).

In the supercritical region (for water, the other side of 374° C. and 22.1 MPa), the substance properties change. Among other things the density of water is reduced by a factor of 10 compared to the ambient conditions, and at the same time the dynamic viscosity sinks by a factor of 20, see FIG. 1, which shows the density ρ and the dynamic viscosity η for pure water as the function of temperature at a pressure of 25 MPa. Therewith the density remains similar to a liquid, while the viscosity assumes the values of gases.

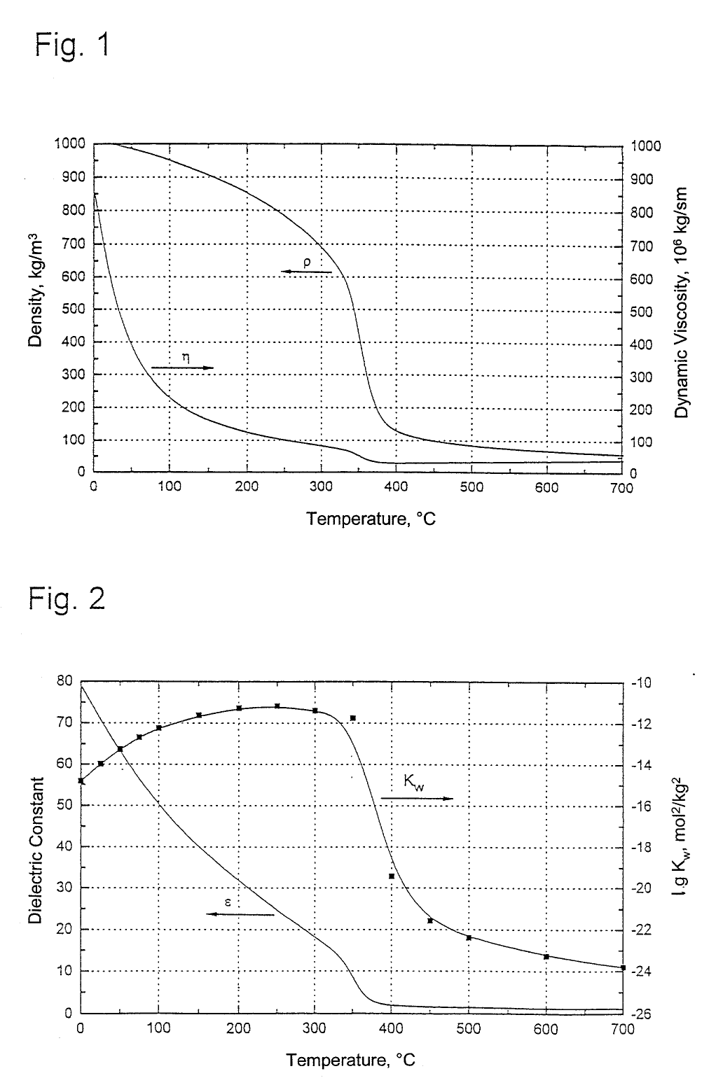

FIG. 2 shows the dielectric constant ε and the ionic product K_{w} for pure water at a pressure of 25 MPa as a function of temperature. The drop of the dielectric constant ε in the supercritical region is explained in chemistry by the removal of the hydrogen intermolecular bonding, that is, water is increasingly less polar with increasing approach to the critical point, and in the supercritical water behaves almost non-polar (Clifford, A. A.: see above). In addition, the ionic product increases strongly multiple tens of percent, that is, the conductivity increases correspondingly.

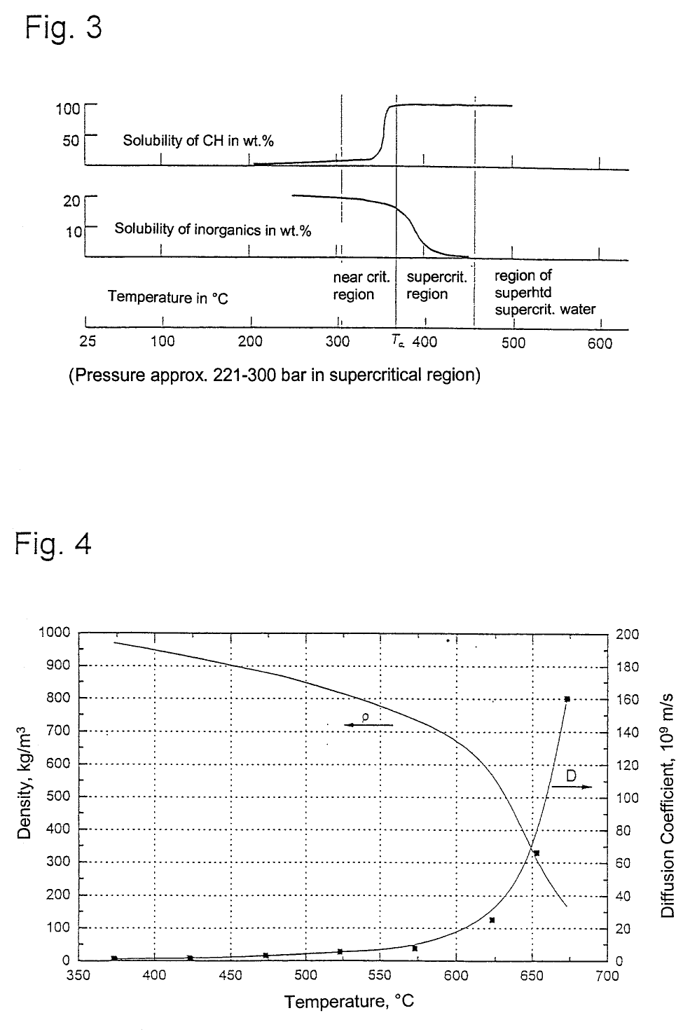

The resulting changes in solubility characteristics are illustrated in FIG. 3, which shows the solubility of organic (CH, carbohydrates) and inorganic materials in water as a function of temperature; the measurements were made at supercritical pressures of 22.1 through 30 MPa. Hydrocarbons are almost unlimitedly soluble above the near critical region, while going in the opposite direction the solubility of inorganic materials strongly decreases on the other side of the critical temperature (Modell, M,: Paulaitis, M. E.: Supercritical Fluids, Environ. Sci. Technol.; Vol. 16; No. 10, 1982).

One indicator for the behavior as a reaction medium is FIG. 4, which shows the density ρ of pure water and the diffusion coefficient D of a strongly diluted benzole solution as a function of temperature at a pressure of 25 MPa (Caroll, J. C.: Ph.D. Thesis, University of Leeds, UK, 1992). The high diffusion of the water in the supercritical range brings about that reactions are not determined by material exchange, but rather primarily by kinetics.

As determined by the high solubility of organic materials and gases in supercritical water the relevant reactive system exists as one phase between polymer, water and oxygen. Aided by the high diffusion, rapid reactions occur, which in general lie in the range of minutes, while other thermo-chemical processes require hours or days.

In the treatment of solid waste materials by supercritical wet oxidation the solids are dispersed in water and elevated to supercritical pressure. Subsequently the temperature is increased to the desired range, preferably into the supercritical range.

The organic components go into solution and are hydrolytically partially decomposed. By the addition of an oxidation aid, for example oxygen, H₂O₂ or air, the decomposition is made complete. Organics are converted into carbon dioxide, water and molecular hydrogen. Any present halogens are converted into corresponding salts. Therein available metals serve as cation donors. Otherwise, the metals oxidize and act catalytically in the reactions. In the case of the presence of ceramic components, these have no effect on the chemical processes. They remain insoluble under all conditions. Also unsoluble at conventional conditions of supercritical wet oxidation (25-30 MPa, 500-600° C.) are the produced salts. It is however also conceivable to keep the salts in solution by very high pressures—up to 100 MPa.

At the end of the reaction phase the temperature is reduced and ambient pressure is restored. Subsequently the reaction products can be separated from each other according to the phases “gas”, “liquid” and “solid”.

In the treatment of solids by supercritical wet oxidation there exists a series of difficulties or problems. Supercritical water already places increased demands or stresses on the (vessel) material due to the combination of high pressure (23-30 bar) and increased temperatures (400-600° C.) as well as strongly acidic conditions. The occurrence of a reaction as well as abrasion due to solids further increases the stresses. Particularly problematic is the presence of halogens. Here, the highest corrosion erosion occurs at the critical (T=374° C.) or, as the case may be, pseudo critical temperature (the pseudo critical temperature is the temperature shifted to higher temperatures depending upon pressure, for example 405° C. for a pressure of 30 MPa). One solution is to keep the process parameters as mild as possible, for example by lowing the temperature, and by appropriate process design or, as the case may be, by the design of the reactor, to decouple the stresses, for example by flowing a cold layer along the reaction wall. In the first example—the lower temperatures—longer dwell times are necessary for the same decomposition rate, as a result of which one requires a larger unit. The second example—cold boundary layer flow —requires elaborate constructive measures.

A further difficulty in the treatment of solids by supercritical wet oxidation is sedimentation, the tendency of the particles to deposit to the floor of the apparatus. On the basis of the changed fluid characteristics in the supercritical range as compared to ambient conditions the rates of precipitation of introduced solid particles substantially increases. The sedimentation can be avoided in that one employs a horizontal pipe reactor. At appropriate high flow-through speeds the suspension remains stable. Research has shown that it is less problematic to keep the suspension stable in supercritical water than in liquid water. That is, with decreasing density the flow speed in the pipe reactor increases inversely proportionally and overcompensates for the higher precipitation speeds (Pilz, S.: Modeling, Design and Scale-Up of an SCWO Application Treating Solid Residues of Electronic Scrap Using a Tubular Type Reactor-Fluid Mechanics, Kinetics, Process Envelope, VDI-GVC High Pressure Chemical Engineering Meeting; 03-05, Mar. 1999, Karlsruhe).

A suspension reactor is exposed to increased abrasion due to the solid particles. The use of apparatus (valves, measurement devices) results in further difficulties or problems on the basis of changes of the pipe internal diameter and stronger changes in the flow direction. Here particles, in particular fibers, can result in clogging. On the basis of the higher flow velocities there results a longer reactor and a not very compact construction.

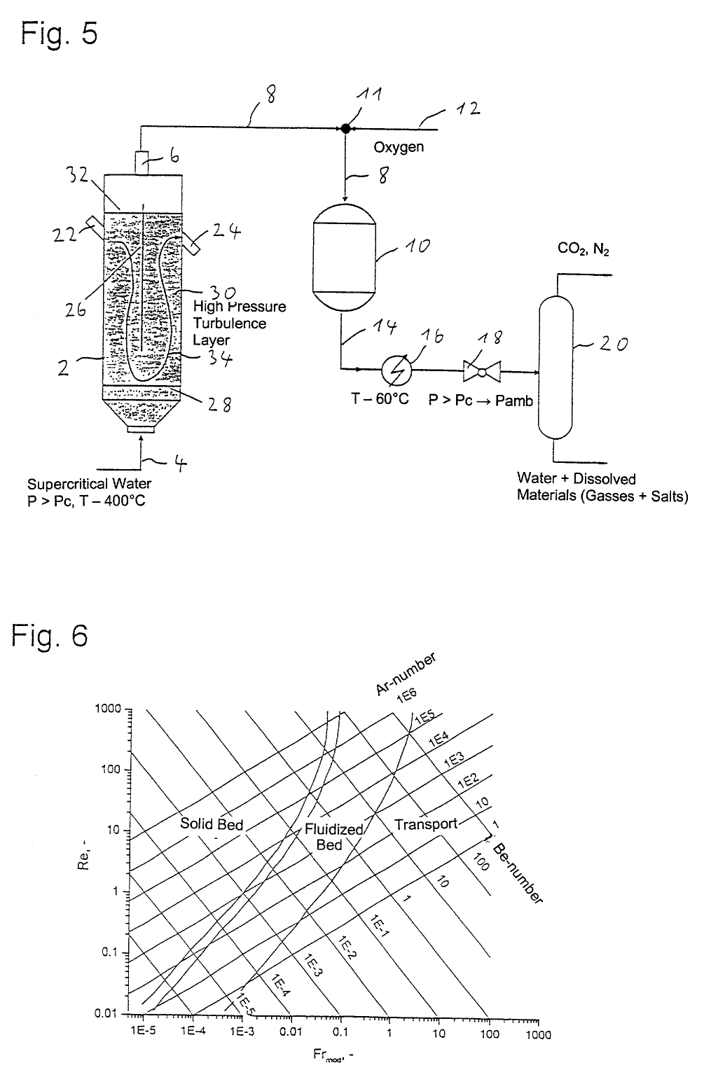

FIG. 5 is a schematic diagram of a first embodiment of an apparatus for supercritical wet oxidation of a waste material mixture in a turbulence layer. The apparatus includes an elongated, vertically upright high-pressure vessel 2, which receives supercritical water entering from below via a conduit 4. An outlet 6 at the upper side of the high-pressure vessel 2 is connected via a conduit 8 with a CSTR (Continuously Stirred Tank Reactor; conventional tank with stirrer) 10 or another suitable high-pressure reactor. In the conduit 8, there is further a mixer 11, which is connected with an oxygen supply source via conduit 12. From the outlet of the CSTR 10 a conduit 14 passes through a heat exchanger 16 and a depressurizing valve 18 to a separator 20.

The high pressure vessel 2 includes an inlet 22 for the introduction of solids and an outlet 24 for the removal of solids, a vertical separation wall 26 and a horizontal separation wall 28 with a plurality of narrow holes, which separates the lower inlet for supercritical water from the central and upper areas of the high pressure vessel 2.

In operation the supercritical water flows with pressure P of preferably 23-30 MPa, which lies above the critical pressure P_{C}, and a temperature T of preferably 380-450° C., for example 400° C., continuously upwards from below through a high pressure vessel 2 and then through the CSTR 10, the heat exchanger 16 and the pressure reducing valve 18 into the separator 20.

A waste material mixture to be treated in the apparatus, for example electronic debris or waste products or the shredder light fraction from automobile recycling, is shredded in a not shown unit. The waste material particles are introduced into the high-pressure vessel 2 via the inlet 22, for example via a sluice or lock. In the case of continuous introduction the waste material particles can also be suspended in some water and be added with the water through the inlet 22.

The speed of the vertical flow of the supercritical water in the high-pressure vessel 2 is so selected that the charge of the introduced particles is loosened up and fluidized, without the particles reaching the upper outlet 6 of the high-pressure vessel 2. Thereby, a turbulence layer 30 is formed, which exhibits for example the upper boundary 32.

In the turbulence layer 30, the particles move over time from inlet 22 to outlet 24, wherein the vertical separation wall 26 or multiple of such separation walls cause a long as possible transport path, as indicated with a curved line 34, in order to increase the dwell time of the particles in the high-pressure vessel 2.

In the high-pressure vessel 2 the organic components of the waste material dissolve in the supercritical water.

The substances removed at outlet 24 are substantially solid inert substances, which can be easily recycled or disposed of. It is to be expected that the charge material separates according to particle size and substance density. This is not a problem in the present case, since the inert and metallic materials generally are heaviest and substantially heavier than the organic materials. A small entraining of organic materials is acceptable.

The organic components in the water flowing out of the upper outlet 6 are completely converted in the CSTR 10 under supercritical conditions using oxygen, that is are further cleaved or cracked and essentially are completely oxidized. The end product is substantially gases and salts, which can be dissolved in the supercritical water.

In the heat exchanger 16 the thermal energy is extracted from the water, in order to cool it to approximately that of the ambient temperature, and the pressure reduction valve 12 reduces pressure in the water approximately to the ambient pressure P_{amb}. Thereby gases such as for example CO₂ and N₂ are released and separated in separator 20. Substances remaining dissolved in the water, in particular salts, can be separated in further, not shown, equipment and separately recycled. The remaining water can be reintroduced into the cycle anew, for example in the case that it contains impurities which it would be too expensive or complex to separate.

The turbulence layer 30 and the CSTR 10 are so arranged, that of the three sequential and partially also simultaneously occurring decomposition steps

1) solublization of organics

2) hydrolysis and

3) oxidation of the organics the step 1) essentially occurs in the turbulence bed 30, and step 3) occurs essentially in the CSTR 10. This division is easily possible, since under the same conditions solubilization occurs substantially more rapidly than the oxidation.

The hydrolysis, the partial splitting or cleaving of the reaction educts by the ions present in the water, can either occur in the turbulence layer 30 or in the CSTR 10. Normally a part of the hydrolysis will occur in the turbulence layer 30 and another part will occur in the CSTR 10, so that the organics are present at least as a solution between the turbulence layer 30 and the CSTR 10, partially however are also already decomposed to short chain polymers.

The material of the high-pressure vessel 2, in which the turbulence layer 30 is to be maintained, is subjected to neither strong abrasion by the solid particles, since these move with relatively low speed, nor strong corrosion, since in the fluidized bed layer essentially no aggressive reaction products are present.

The (vessel) materials of the CSTR 10 may be strongly attacked by the corrosive reaction products, however are not subjected to abrasion since the solids have been removed.

In the CSTR 10, there occurs as a result of its stirrer, a complete mixing through in the entire reaction space. The good mixing thorough lowers the reaction time and therewith the dwell time, which for oxidation is normally longer than for the first two decomposition steps. Thus the CSTR 10 need not have a disproportionately large volume, in order to achieve a sufficient dwell time for the materials to be decomposed. On the basis of the good mixing through, the reactions in the CSTR 10 run particularly uniformly, so that extensive instrumentation for avoidance of defects or discontinuities is not necessary.

Besides this, due to the bulge shaped construction of the CSTR 10 it is easy to introduce corrosion preventing or kinetic improving measures such as layerings or components. Corrosion preventing layers and internal components, which protect the reactor wall for example using cooler zones, makes possible higher reaction temperatures and result in correspondingly shorter reaction times.

The volume remaining in the equipment and the large relationship of volume to internal upper surface of the CSTR 10 make possible a very compact manner of construction. This together with the low space requirement for the high-pressure vessel 2, in which the fluidized bed or the case may be the turbulence zone 30 is produced, can result in an overall very compact assembly.

In another, not shown, embodiment the high-pressure vessel 2 is not supplied with supercritical, but rather with near critical water, which preferably has a near or supercritical pressure of for example 25 MPa, however even a sub-critical temperature in the range of 180-300° C. In this case the corrosion exposure of the high-pressure vessel 2 is particularly low. However a longer dwell time is necessary. Subsequent to the high-pressure vessel 2 the temperature and pressure can be elevated again by means of a supplemental heat exchanger, in case the reaction dependent temperature increase in the CSTR 10 does not suffice for the further decomposition.

In a further, not shown, illustrative embodiment the CSTR 10 is omitted, that is, the outlet 6 of the high-pressure vessel 2 is connected directly with the heat exchanger 16, and the oxygen together with the supercritical water is introduced into the high-pressure vessel 2, so that all above-mentioned reaction steps occur in the turbulence layer 30. In this case the construction material stress or exposure is however increased, also because of the reaction dependent temperature elevation, which can result in the temperature being increased to 600° C.

By the fluidization of the charge material by means of a supercritical fluid the good transport characteristics on the side of the fluid bed technology and on the side of the supercritical fluid are both utilized and synergistically employed. The thermal and material exchange between particle and liquid is very good. The temperatures and concentrations are evenly distributed over the entire fluidized bed, with the exception of the edge zones.

In order to be able to carry out the above-described embodiments selectively in a single unit or assembly, one can employ the following measures:

1. Along the height of the high-pressure vessel 2 there are multiple inlets and outlets.

2. The height of the fluidized bed, that is, its upper limit 32, is adjusted depending upon the respective requirements.

3. Multiple fluidized bed apparatus are connected in parallel.

4. Water can supplementally be added at the mixer 11 prior to the CSTR 10, in order to minimize the caloric value for the further reaction.

Even though the fluid mechanical characteristics of a fluidized bed are similar to that of a liquid, the arrangement or design of a fluidized bed is not trivial. Thus, the theoretical basis and a practical design of a fluidized bed will be described in greater detail in the following.

In the design of the fluidized bed it is to be taken into consideration, that on the one hand the flowing through of the charge must be intensive enough to lift the particles and to fluidize the bed, on the other hand however the particles are to be brought only into suspension and not to be conveyed. In the design, frequently reference must be made to constitutional or equilibrium phase diagrams (as provided for example by Wetzler, H.; Kennzahlen der Verfahrenstechnik, Huthig-Verlag; 1985; Beranek, J.; Rose, K.; Winterstein, G.: Grundlagen der Wirbelschichttechnik; VEB Deutscher Verlag fur Grundstoffindustrie, 1975; Reh, L.: Verbrennung in der Wirbelschicht; Chemie Ingenieur Technik; Vol. 40 (1968)).

Therein four characteristics or values are employed, which essentially describe the fluidized bed. They encompass all parameters for the design of a fluidized bed, namely the characteristics of the fluid (density and viscosity), the characteristics of the solids (density and size) and the flow through (speed and void proportion). The four characteristics place the most important forces into relationships, as indicated in the following equations (1) through (4).

$$\begin{matrix}\begin{matrix}Reynolds & Re = \frac{inertia}{viscosity - force} = \frac{1}{1 - ϵ} vd ρ \frac{F}{η}\end{matrix} & ( 1 ) \\ \begin{matrix}Froude & {Fr}_{mod} = \frac{inertia}{weight} = \frac{{v}^{2}}{dg} ρ \frac{F}{ρ s - ρ F}\end{matrix} & ( 2 ) \\ \begin{matrix}Beranek & Be = {Re}^{*} {Fr}_{mod} = \frac{{v}^{3} ρ F}{g η} ρ \frac{F}{ρ S - ρ F}\end{matrix} & ( 3 ) \\ \begin{matrix}Archimedes & \begin{matrix}Ar = \frac{hydrostatic - upflow}{inertia} \\ = \frac{{Re}^{2}}{{Fr}_{mod}} = \frac{{gd}^{3} ρ {F}^{2}}{η {F}^{2}} ρ S - \frac{ρ F}{ρ F}\end{matrix}\end{matrix} & ( 4 )\end{matrix}$$

It can be seen that respectively one of the variables—ignoring the empty space proportion ε—does not occur in respectively one of the characteristic numbers, see the following table.

TABLE 1
The four relevant dimensionless values for the fluidized bed and its
variables

| dimensionless | | | | | |
|---|---|---|---|---|---|
| characteristic | | | | | |
| number | v | d_{S} | ρ_{S} | ρ_{F} | η_{F} |
| Reynolds | X | X | — | X | X |
| Froude | X | X | X | X | — |
| Beranek | X | — | X | X | X |
| Archimedes | — | X | X | X | X |

While in the conventional fluidized bed layers the characteristics of the fluid (gas or liquid) are almost constant, in the present application using supercritical fluids the characteristics can be varied over a broad range. Therewith there result further freedoms in the design of the apparatus and the carrying out of the process. With the aid of the above presented considerations the process window can be determined using a condition diagram.

FIG. 6 shows the dimensionless condition diagram according to Wetzler (see above). The boundary lines separate from each other—from left to right—fixed bed, fluidized bed and solid substance conveyance. The two close lines between fixed bed and fluidized bed produce the first loosening or as the case may be, complete fluidization behavior.

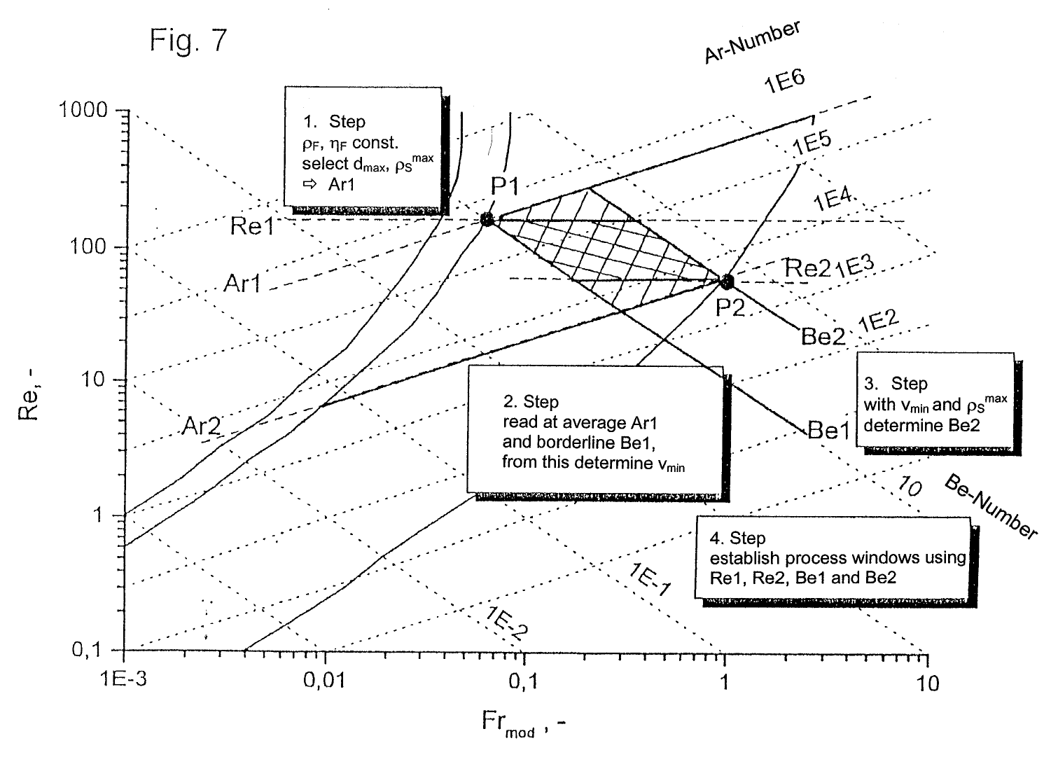

The practical arrangement of the fluidized bed will now be discussed in greater detail on the basis of the schematic shown in the condition diagram of FIG. 7.

For the minimal fluidization the largest particle with the highest density (for example copper) is determinative, while the maximal flow velocity is determined by the smallest lightest particles (for example plastic).

At the initial stage of the design the fluid speed is however not known. For a first approximation the pressure and temperature, and therewith density and viscosity of the fluid, are determined. By using the maximal particle size and the largest solid density the maximal Archimedes-value can be determined (1^{st} step in FIG. 7). The cut off or determinative point with the boundary for complete fluidization is provided by the respective Beranek, Reynolds and Froude values. This produces the minimal fluidization speed (2^{nd} step in FIG. 7). From this speed, which is constant over the apparatus, from the fluid characteristics and from the smallest solid density, the second Beranek value is determined (3^{rd} step in FIG. 7). The threshold of the boundary line for conveyance is determined by the other dimensionless values of the smallest particle, which will not be carried out.

Therewith the process window is determined via the two Beranek and the two Reynolds values by the two threshold points at the respective boundary lines (4^{th} step in FIG. 7). In this example there was optimization to a broad as possible particle size spectrum, since a pre-classification of the solid mixture can easily be carried out. However it is also possible to have a prior step of density sorting. Other considerations could require a higher fluid speed, which would narrow the trapezoid.

Up to this point the design occurs according to standard methodology. In contrast to fluidized bed layers with conventional fluids, supercritical fluids can be employed in the present application for the further optimization for the individual applications and also for varying the fluid conditions. Thereby not only the placement of the process window changes, but rather on the basis of the contour of the boundary lines, also its size. Since the dependencies for densities and viscosity vary for pressure and temperature (see FIG. 1, 2), this can be intentionally used to advantage. Most significant is however the change in the liquid-solid density difference (see Equations 2, 3, 4).

In summary, in the preferred embodiments the process and the reaction zones are divided into two segments. The solids are found only in the first part, the organic components are dissolved here and partially decomposed. In the second segment the organic materials to be treated are in liquid form and are further decomposed. Thus, the stresses due to particles are avoided in the second part.

The solid material reactor is designed based on a turbulent layer. This has very good transport characteristics in comparison to a fixed bed reactor, since the particles do not lie directly upon each other. Rather, they float or are suspended freely in the liquid. On the other hand, the construction size and the stresses are not as high as in a case of a long suspension pipe reactor.

The combination of supercritical fluid conditions and loosening turbulence layer result in good transport characteristics. In contrast to conventional turbulence layers, the fluid parameters of density and viscosity are broadly variable via temperature and pressure. This increases the degree of freedom in the design of the turbulence zone.

What is claimed is:

1. Process for supercritical wet oxidation of a waste material mixture, which includes particles comprised of organic and inorganic components, thereby characterized, p1 that the waste material mixture is introduced into a vessel (2), p1 that the vessel is continuously flowed through by water in the direction counter to gravity, p1 that a near critical or supercritical condition exists, p2 wherein the flow velocity is so selected, p3 that the particles are kept in suspension, however are not transported in the direction of flow, thereby forming a defined turbulence layer (30) having an upper boundary (32), p3 that solids present in the water are discharged, and p3 that fluid, which is located above the upper boundary (32) of the turbulence layer, is continuously removed from the vessel.

2. Process according to claim 1, thereby characterized, that in addition an oxidation agent is introduced into the vessel (2).

3. Process according to claim 1, thereby characterized, that the fluid which is removed out of the vessel (2) from above the upper boundary (32) of the turbulence layer (30), together with an oxidation agent, is transferred to a reactor (10), in which the water likewise exists in a near critical or supercritical condition, in order to essentially completely oxidize the organic components therein.

4. Process according to one of the preceding claims, thereby characterized, that fluid exiting from the vessel (2) or the reactor (10) is cooled and depressurized, and that gases and liquids, which are contained in the cooled and decompressed fluid, are separated from each other.

5. Process according one of the preceding claims, thereby characterized, that the waste material mixture is selected from the group consisting of electronic waste material and a shredder light fraction from an automobile recycling process.

6. Device for supercritical wet oxidation of a waste material mixture, which mixture contains particles of organic and inorganic components, thereby characterized, that the device is designed for forming a high pressure turbulence layer (30) of particles of the waste material mixture kept in suspension by water which is in a near critical or supercritical condition and continuously flowed contrary to the direction of gravity.

7. Device according to claim 6, characterized by
a vessel (2)
in which the high pressure turbulence layer (30) is formed with an upper boundary (32),
with a water inlet (4) at the base of the vessel,
with a fluid outlet (6) above the upper boundary of the turbulence layer, and
with inlet and outlet means (22, 24) for the solid particles, which means are provided below the upper boundary of the turbulence layer.

8. Device according to claim 7, characterized by a reactor (10), of which the fluid inlet is connected with the fluid outlet (6) of the container (2) and which is connected with a source (12) for an oxidizing agent.

9. Device according to claim 8, thereby characterized, that a fluid outlet of the reactor (10) is connected via cooling and depressurizing devices (16, 18) with a separator (20) for separating gases and liquids.
